(19) United States
(12) Patent Application Publication
(10) Pub. No.: US 2009/0234565 A1
(43) Pub. Date: Sep. 17, 2009

(54) Navigation Device and Method for Receiving and Playing Sound Samples

(76) Inventor: Pieter Andreas Geelen, Amsterdam (NL)

Correspondence Address: HARNESS, DICKEY & PIERCE, P.L.C., P.O. BOX 8910, RESTON, VA, 20195, US

(21) Appl. No.: 12/223,537

(22) PCT Filed: Feb. 19, 2007
(86) PCT No.: PCT/NL2007/050068

§ 371 Date: Aug. 1, 2008

(30) Foreign Application Priority Data
Feb. 21, 2006 (NL) 1031202

(51) Int. Cl. G01C 21/00; G10L 13/00

(52) U.S. Cl. 701/200; 704/260; 704/E13.005

(57) ABSTRACT

A navigation device is disclosed including a processor unit, memory device, and a speaker. The memory device includes a plurality of sound samples. In at least one embodiment, the navigation device is arranged to play a selection of the sound samples over speaker to provide navigation instructions. In at least one embodiment, the navigation device further includes an input device for receiving sound samples and is arranged for storing the received sound samples in memory device for subsequent playback over speaker for providing navigation instructions.

### TECHNICAL FIELD

The present invention relates to a navigation device comprising a processor unit, memory device and a speaker, the memory device comprising a plurality of sound samples, the navigation device being arranged to play a selection of the sound samples over speaker to provide navigation instructions.

Also, the present invention relates to a vehicle, comprising such a navigation device, a method for recording a set of sound samples, method for providing navigation instructions, a computer program, and a data carrier.

### STATE OF THE ART

Prior art navigation devices based on GPS (Global Positioning System) are well known and are widely employed as in-car navigation systems. Such a GPS based navigation device relates to a computing device which in a functional connection to an external (or internal) GPS receiver is capable of determining its global position. Moreover, the computing device is capable of determining a route between start and destination addresses, which can be input by a user of the computing device. Typically, the computing device is enabled by software for computing a “best” or “optimum” route between the start and destination address locations from a map database. A “best” or “optimum” route is determined on the basis of predetermined criteria and need not necessarily be the fastest or shortest route.

The navigation device may typically be mounted on the dashboard of a vehicle, but may also be formed as part of an on-board computer of the vehicle or car radio. The navigation device may also be (part of) a hand-held system, such as a PDA.

By using positional information derived from the GPS receiver, the computing device can determine at regular intervals its position and can display the current position of the vehicle to the user. The navigation device may also comprise memory devices for storing map data and a display for displaying a selected portion of the map data.

Also, it can provide instructions how to navigate the determined route by appropriate navigation instructions or driving instructions displayed on the display and/or generated as audible signals from a speaker (e.g. ‘turn left in 100 m’). Graphics depicting the actions to be accomplished (e.g. a left arrow indicating a left turn ahead) can be displayed in a status bar and also be superimposed upon the applicable junctions/turnings etc. in the map itself.

It is known to enable in-car navigation systems to allow the driver, whilst driving in a car along a route calculated by the navigation system, to initiate a route re-calculation. This is useful where the vehicle is faced with construction work or heavy congestion.

It is also known to enable a user to choose the kind of route calculation algorithm deployed by the navigation device, selecting for example from a ‘Normal’ mode and a ‘Fast’ mode (which calculates the route in the shortest time, but does not explore as many alternative routes as the Normal mode).

It is also known to allow a route to be calculated with user defined criteria; for example, the user may prefer a scenic route to be calculated by the device. The device software (navigation software) would then calculate various routes and weigh more favourably those that include along their route the highest number of points of interest (known as POIs) tagged as being for example of scenic beauty.

It is known to guide the user by means of voice instructions. Voice instructions may be pre-recorder phrases like ‘turn left’ or may be generated dynamically based on map and/or route information using a text-to-speech device. In case of text-to-speech, the voice instruction is created using a text-to-speech database with phonetic data. This database may contain also pre-defined short voice fragments, sounds, etc.

It is the object to provide a navigation device with additional functionality and to provide the user with the option to modify the navigation device according to his/her preferences.

### SHORT DESCRIPTION

According to an aspect the invention provides a navigation device comprising a processor unit, memory device and a speaker, the memory device comprising a plurality of sound samples, the navigation device being arranged to play a selection of the sound samples over speaker to provide navigation instructions, characterized in that the navigation device further comprises an input device for receiving sound samples and is arranged for storing the received sound samples in memory device for subsequent playback over speaker for providing navigation instructions. This provides a user with the option to modify the navigation device according to his/her preferences.

According to an embodiment the input device comprises a microphone. This provides an easy way for a user to input new sound samples, such as voice samples, which are easy to understand by a user.

According to an embodiment the selection of sound samples is played over speaker using text-to-speech voice generation and wherein the navigation instructions are generated from the received sound samples using text-to-speech voice generation.

According to an embodiment no whole sentences need to be recorded, but only a number of sounds etc. This provides a flexible way of playing navigation instructions, also allowing playing new navigation instructions not known at the time of recording.

According to an embodiment the input device comprises an input/output device, arranged to exchange sound samples with other devices, such as other navigation devices. This allows exchanging sound samples between different devices.

According to an embodiment the plurality of sound samples are organized in two or more profiles, where each profile comprises a number of sound samples, and each sound sample has a sample identification assigned to it, where each sample identification represents a navigation instruction or part of a navigation instruction.

According to an embodiment the navigation device is arranged to store a sound sample received from the input device in a profile in the memory device and assign a sample identification to the sound sample.

According to an embodiment the navigation device is arranged to create a new profile and store a sound sample received from the input device in the new profile in the memory device and assign a sample identification to the sound sample.

According to an embodiment the navigation device being arranged to play a selection of the sound samples over speaker to provide navigation instructions from a first profile, and when a sound sample of the selection having a sample identification is not available in a first profile, the navigation device plays a similar sound sample from a second profile. This allows the navigation device to use a profile that is not complete, without risking giving incomplete navigation instructions. The similar sound sample may for instance be a sound sample having a same sample identification.

According to an embodiment the navigation device is arranged to play a selection of the sound samples over speaker to provide navigation instructions from a first profile, and when at least one sound sample of the selection having sample identifications is not available in a first profile, the navigation device plays all sound sample of the selection from a second profile having the same sample identifications. This prevents navigation instruction to be spoken by two or more different voices. The sound samples may for instance be a sound samples having similar sample identifications.

According to an embodiment wherein the first and second profile are in an hierarchical order with respect to each other. This makes it possible for the navigation device to effectively switch between profiles.

According to an aspect the invention relates to a vehicle, comprising a navigation device according to any one of the preceding claims.

According to an aspect the invention relates to a method comprising:

recording a sound sample using an input device for receiving sound samples,

storing the recorded sound sample in memory device for subsequent playback for providing navigation instructions.

According to an embodiment, where sample identifications are assigned to sound samples, the sample identifications representing navigation instructions or part of navigation instructions, the method comprising before recording the sound sample using an input device for receiving sound samples:

providing an example for a sound sample having a sample identification to a user, and, when storing the recorded sound sample,

assigning a unique identification code to it, at least comprising the sample identification.

According to an embodiment, the example is provided via at least one of: display, a speaker. This is an easy and straightforward way to provide the user with an example.

According to an aspect the invention relates to a method for providing navigation instructions by playing a selection of sound samples from a first profile over a speaker, the method comprising:

retrieving sound samples from memory device according to the selection of sound samples, and, if one or more of the selection of sound samples is not available in the first profile,

retrieving the one or more sound samples not available in the first profile from a second profile stored in memory device.

According to an embodiment, if at least one the selection of sound samples is not available in the first profile, the method comprises:

retrieving all sound samples of the selection from the second profile stored in memory device.

According to an aspect, the invention relates to a computer program, when loaded on a computer arrangement, arranged to perform the method according to the above.

According to an aspect, the invention relates to a data carrier, comprising a computer program according to the above.

### SHORT DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a schematic block diagram of a navigation device,

FIG. 2 schematically depicts a schematic view of a navigation device,

FIG. 3 schematically depicts different profiles stored in memory devices according to the prior art,

FIGS. 4a, 4b and 4c schematically depict images as displayed by a navigation device according to an embodiment,

FIG. 5 schematically depicts a flow diagram according to an embodiment,

FIGS. 6a and 6b schematically depict different profiles stored in memory devices according to an embodiment,

FIG. 7 schematically depicts a flow diagram according to an embodiment.

### DETAILED DESCRIPTION

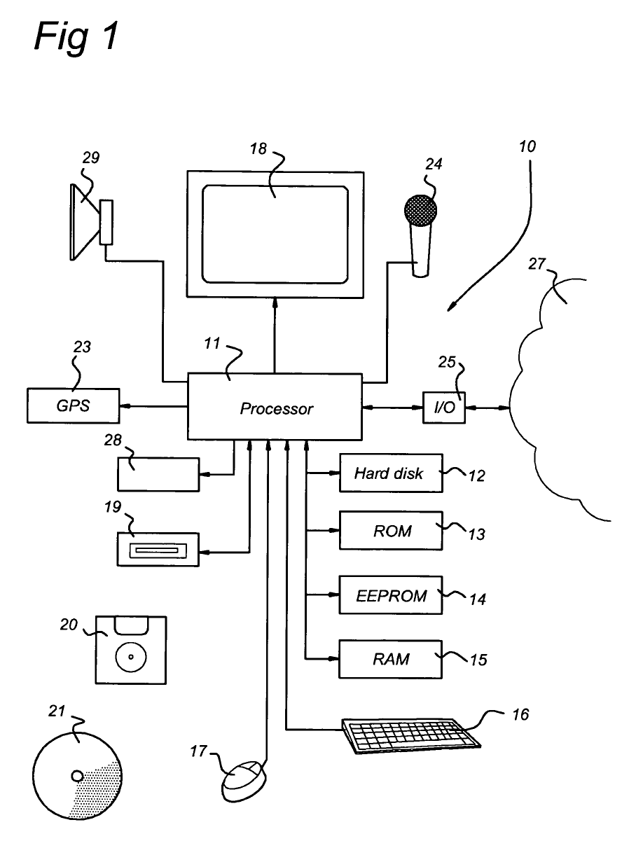

FIG. 1 shows a schematic block diagram of an embodiment of a navigation device 10, comprising a processor unit 11 for performing arithmetical operations. The processor unit 11 is arranged to communicate with memory units that store instructions and data, such as a hard disk 12, a Read Only Memory (ROM) 13, Electrically Erasable Programmable Read Only Memory (EEPROM) 14 and a Random Access Memory (RAM) 15. The memory units may comprise map data 22. This map data may be two dimensional map data (latitude and longitude), but may also comprise a third dimension (height). The map data may further comprise additional information such as information about petrol/gas stations, points of interest. The map data may also comprise information about the shape of buildings and objects along the road.

The processor unit 11 may also be arranged to communicate with one or more input devices, such as a keyboard 16 and a mouse 17. The keyboard 16 may for instance be a virtual keyboard, provided on a display 18, being a touch screen. The processor unit 11 may further be arranged to communicate with one or more output devices, such as a display 18, a speaker 29 and one or more reading units 19 to read for instance floppy disks 20 or CD ROM's 21. The display 18 could be a conventional computer display (e.g. LCD) or could be a projection type display, such as the head up type display used to project instrumentation data onto a car windscreen or windshield. The display 18 may also be a display arranged to function as a touch screen, which allows the user to input instructions and/or information by touching the display 18 with his finger.

The speaker 29 may be formed as part of the navigation device 10. In case the navigation device 10 is used as an in-car navigation device, the navigation device 10 may use speakers of the car radio, the board computer and the like. The navigation device 10 may be connected to the speaker 29, for instance via a docking station, a wired link or a wireless link.

The processor unit 11 may further be arranged to communicate with a positioning device 23, such as a GPS receiver, that provides information about the position of the navigation device 10. According to this embodiment, the positioning device 23 is a GPS based positioning device 23. However, it will be understood that the navigation device 10 may implement any kind of positioning sensing technology and is not limited to GPS. It can hence be implemented using other kinds of GNSS (global navigation satellite system) such as the European Galileo system. Equally, it is not limited to satellite based location/velocity systems but can equally be deployed using ground-based beacons or any other kind of system that enables the device to determine its geographical location.

However, it should be understood that there may be provided more and/or other memory units, input devices and read devices known to persons skilled in the art. Moreover, one or more of them may be physically located remote from the processor unit 11, if required. The processor unit 11 is shown as one box, however, it may comprise several processing units functioning in parallel or controlled by one main processor that may be located remote from one another, as is known to persons skilled in the art.

The navigation device 10 is shown as a computer system, but can be any signal processing system with analogue and/or digital and/or software technology arranged to perform the functions discussed here. It will be understood that although the navigation device 10 is shown in FIG. 1 as a plurality of components, the navigation device 10 may be formed as a single device.

The navigation device 10 may use navigation software, such as navigation software from TomTom B.V. called Navigator. Navigation software may run on a touch screen (i.e. stylus controlled) Pocket PC powered PDA device, such as the Compaq iPaq, as well as devices that have an integral GPS receiver 23. The combined PDA and GPS receiver system is designed to be used as an in-vehicle navigation system. The embodiments may also be implemented in any other arrangement of navigation device 10, such as one with an integral GPS receiver/computer/display, or a device designed for non-vehicle use (e.g. for walkers) or vehicles other than cars (e.g. aircraft).

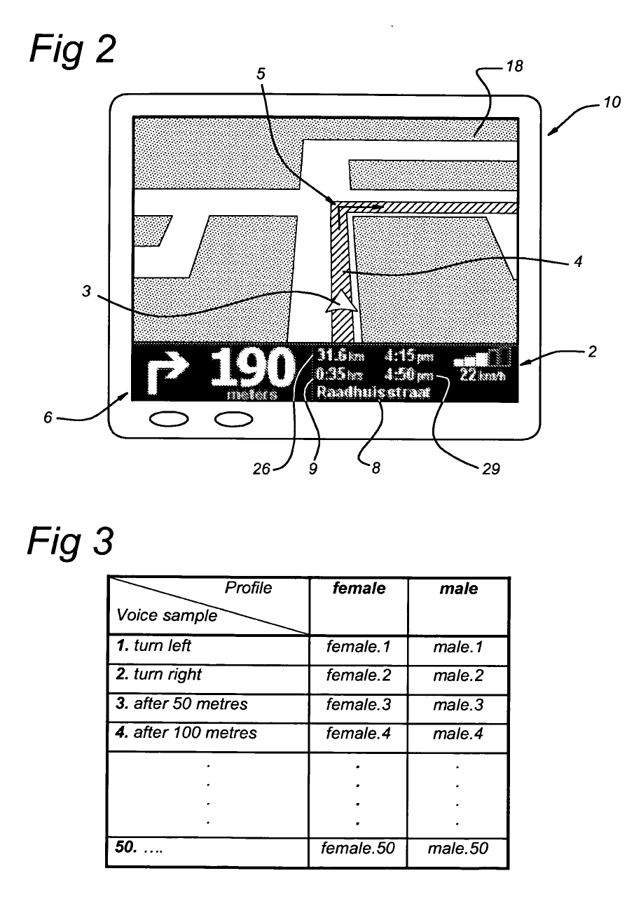

FIG. 2 depicts a navigation device 10 as described above.

Navigation software, when running on the navigation device 10, causes a navigation device 10 to display a normal navigation mode screen at the display 18, as shown in FIG. 2. This view may provide navigation instructions using a combination of text, symbols, voice guidance and a moving map. Key user interface elements are the following: a 3-D map occupies most of the screen. It is noted that the map may also be shown as a 2-D map.

The map shows the position of the navigation device 10 and its immediate surroundings, rotated in such a way that the direction in which the navigation device 10 is moving is always “up”. Running across the bottom quarter of the screen may be a status bar 2. The current location of the navigation device 10 (as the navigation device 10 itself determines using conventional GPS location finding) and its orientation (as inferred from its direction of travel) is depicted by a position arrow 3. A route 4 calculated by the device (using route calculation algorithms stored in memory devices 12, 13, 14, 15 as applied to map data stored in a map database in memory devices 12, 13, 14, 15) is shown as darkened path. On the route 4, all major actions (e.g. turning corners, crossroads, roundabouts etc.) are schematically depicted by arrows 5 overlaying the route 4. The status bar 2 also includes at its left hand side a schematic icon depicting the next action 6 (here, a right turn). The status bar 2 also shows the distance to the next action (i.e. the right turn—here the distance is 190 meters) as extracted from a database of the entire route calculated by the device (i.e. a list of all roads and related actions defining the route to be taken). Status bar 2 also shows the name of the current road 8, the estimated time before arrival 9 (here 35 minutes), the actual estimated arrival time 29 (4.50 pm) and the distance to the destination 26 (31.6 km). The status bar 2 may further show additional information, such as GPS signal strength in a mobile-phone style signal strength indicator.

As described above, the navigation device 10 may use voice guidance to guide a user along the route. Therefore, a set of for instance 50 voice samples may be stored in the memory devices 12, 13, 14, 15. These voice samples may for instance be:
1) turn left,
2) turn right,
3) after 50 metres,
4) after 100 metres,
. . .
50) . . .

Also, different sets of voice samples may be stored in the memory devices 12, 13, 14, 15. A first set may for instance comprise voice samples of a female voice. A second set may for instance comprise samples of a male voice. A third set may for instance comprise voice samples of a celebrity. Different sets of voice samples may be denoted with different profiles, for instance “female”, “male” and “celebrity”.

FIG. 3 depicts how different profiles may be stored in memory devices 12, 13, 14, 15, comprising two profiles: female and male. Each voice sample belongs either to the female profile or the male profile. Also, each voice sample has a number assigned to it, which represents the meaning of the voice sample. For instance, all voice samples having sample identification 1 assigned to it may comprise the phrase: “turn left”, and all voice samples having sample identification 2 assigned to it, may comprise the phrase: “turn right”.

Based on these parameters, each voice sample may be given a unique identification code: profile.number, for instance male.2.

When a next navigational direction needs to be communicated to the user, the navigation device 10 is arranged to retrieve the proper voice sample or plurality of voice samples from the memory devices 12, 13, 14, 15, based on a selected profile (e.g. male) and one or more sample identifications (e.g. 4 and 1) as determined by the navigation software and play them over the speaker 29. The navigation device 10 is arranged to play more than one voice sample successively, in this example: male.4 and male.1. In the example given, this results in playing the phrase: “after 100 metres, turn left”.

According to an alternative, instead of retrieving voice samples from the memory device 12, 13, 14, 15, text-to-speech techniques may be used. In case of text-to-speech, the navigation instructions that are to be played over speaker 29 is created using a text-to-speech database with phonetic data. This database may contain with phonetic data, such as pre-defined short sound samples (voice fragments, sounds, etc). Based on the text of a determined navigation instruction, that corresponding sound samples are retrieved from the memory device 12, 13, 14, 15 and the navigation instruction is compiled by putting together the corresponding sound samples.

It will be understood that the memory device 12, 13, 14, 15 may comprise programming instructions readable and executable by the processor unit 11 to perform text-to-speech operations, as known to a person skilled in the art. The navigation device 10 may also comprise a speech generator.

Also a combination the two possibilities mentioned above to generate and play navigation instructions over speaker 29 may be used, i.e. storing voice samples and using text-to-speech techniques. So, part of the navigation instruction may be directly retrieved from memory, while other part of the navigation instruction is generated using text-to-speech techniques.

As already mentioned above, the navigation device may comprise input devices, such as a touch screen, that allows the users to call up a navigation menu (not shown). From this menu, other navigation functions can be initiated or controlled. Allowing navigation functions to be selected from a menu screen that is itself very readily called up (e.g. one step away from the map display to the menu screen) greatly simplifies the user interaction and makes it faster and easier. The navigation menu includes the option for the user to input a destination.

The actual physical structure of the navigation device 10 itself may be fundamentally no different from any conventional handheld computer, other than the integral GPS receiver 23 or a GPS data feed from an external GPS receiver. Hence, memory devices 12, 13, 14, 15 store the route calculation algorithms, map database and user interface software; a processor unit 12 interprets and processes user input (e.g. using a touch screen to input the start and destination addresses and all other control inputs) and deploys the route calculation algorithms to calculate the optimal route. ‘Optimal’ may refer to criteria such as shortest time or shortest distance, or some other user-related factors.

More specifically, the user inputs his start position and required destination into the navigation software running on the navigation device 10, using the input devices provided, such as a touch screen 18, keyboard 16 etc. The user then selects the manner in which a travel route is calculated: various modes are offered, such as a ‘fast’ mode that calculates the route very rapidly, but the route might not be the shortest; a ‘full’ mode that looks at all possible routes and locates the shortest, but takes longer to calculate etc. Other options are possible, with a user defining a route that is scenic—e.g. passes the most POI (points of interest) marked as views of outstanding beauty, or passes the most POIs of possible interest to children or uses the fewest junctions etc.

The navigation device 10 may further comprise an input-output device 25 that allows the navigation device to communicate with remote systems, such as other navigation devices 10, personal computers, servers etc., via network 27. The network 27 may be any type of network 27, such as a LAN, WAN, Blue tooth, internet, intranet and the like. The communication may be wired or wireless. A wireless communication link may for instance use RF-signals (radio frequency) and a RF-network.

Roads themselves are described in the map database that is part of navigation software (or is otherwise accessed by it) running on the navigation device 10 as lines—i.e. vectors (e.g. start point, end point, direction for a road, with an entire road being made up of many hundreds of such sections, each uniquely defined by start point/end point direction parameters). A map is then a set of such road vectors, plus points of interest (POIs), plus road names, plus other geographic features like park boundaries, river boundaries etc, all of which are defined in terms of vectors. All map features (e.g. road vectors, POIs etc.) are defined in a co-ordinate system that corresponds or relates to the GPS co-ordinate system, enabling a device's position as determined through a GPS system to be located onto the relevant road shown in a map.

Route calculation uses complex algorithms that are part of the navigation software. The algorithms are applied to score large numbers of potential different routes. The navigation software then evaluates them against the user defined criteria (or device defaults), such as a full mode scan, with scenic route, past museums, and no speed camera. The route which best meets the defined criteria is then calculated by the processor unit 11 and then stored in a database in the memory devices 12, 13, 14, 15 as a sequence of vectors, road names and actions to be done at vector end-points (e.g. corresponding to pre-determined distances along each road of the route, such as after 100 meters, turn left into street x).

According to an embodiment, the navigation device 10 further comprises a microphone 24, as is schematically depicted in FIG. 1. The microphone 24 may be arranged to register sound (acoustic waves), for instance a voice of a user, and transfer the registered sound in the form of an electrical sound signal. The microphone outputs this electrical sound signal in the form of an analogue or digital electrical sound signal. This electrical sound signal may be processed by the processor unit 11 and stored in the memory devices 12, 13, 14, 15.

The microphone 24 may directly transfer the registered sound into a digital electrical sound signal. However, in case the microphone 24 outputs an analogue electrical sound signal, the navigation device 10 may be arranged to transfer the analogue electrical sound signal into a digital electrical sound signal.

It will be understood that the microphone 24 may be formed as a part of the navigation device 10, but may also be an external microphone 24 that may be connected to the navigation device 10 via an appropriate connection (wire, plug and socket). The navigation device 10 may also be connected to the microphone via a docking station.

The microphone 24 and the speaker 29 may also be formed as a single device that may function as a microphone and speaker, as will be understood by a person skilled in the art. The microphone 24 and the speaker 29 may also be a microphone 24 and speaker 29 of a telephone, the telephone being arranged to be connected to the navigation device via a wired or wireless link (Bluetooth).

According to an embodiment, the navigation device 10 is arranged to record a new set of voice samples using microphone 24) for subsequent playback over speaker (29) for providing navigation instructions. In order to do this, the navigation device 10 may be arranged to provide the user with an option to record a new set of voice samples using microphone 24, for instance by displaying a “Record your own voice” icon on display 18. When a user selects this option, the user is guided through an interactive process which enables him/her to add a new set of voice samples. The user may give the navigation device 10 instructions via one of the input devices, such as a keyboard 16 and a mouse 17. The keyboard 16 may for instance be a virtual keyboard, provided on a display 18, being a touch screen. In case the display is a touch screen the navigation device 10 may show virtual buttons on the screen the user may select by pressing the display 18 at the appropriate position.

The interactive process results in a new self-recorded set of voice samples that may be used by the navigation device 10 to provide navigation instructions and to use voice guidance to guide a user along the route.

After the user has selected the option to record a new set of voice samples, the navigation device 10 may guide the user through an interactive program or process. As a first screen, the navigation device 10 may display via display 18 and/or play via speaker 29 the following introduction message:
“You are going to record your own voice samples.
There are about 50 word samples to be recorded.
The process normally takes around 15 minutes.
We recommend that you go to a silent location in order to make ‘clean’ recordings.
Please note: it is not necessary to record every voice sample. Voice samples that you did not record will be spoken (when required) by one of an already existing voice sample.”

The navigation device 10 further provides the user with the option to stop or continue with the interactive process to record a new set of voice samples.

According to an embodiment, the navigation device 10 may ask the user to input a profile name for the new set of voice samples that is to be recorded. The user may input such a profile name using keyboard 16 or selecting a profile name from a list of profile names the navigation device 10 has stored in the memory devices 12, 13, 14, 15.

According to a further embodiment, the profile name for the new set of voice samples may be automatically generated by the navigation device 10, and may for instance be named: “Own recorded profile” or “new profile”.

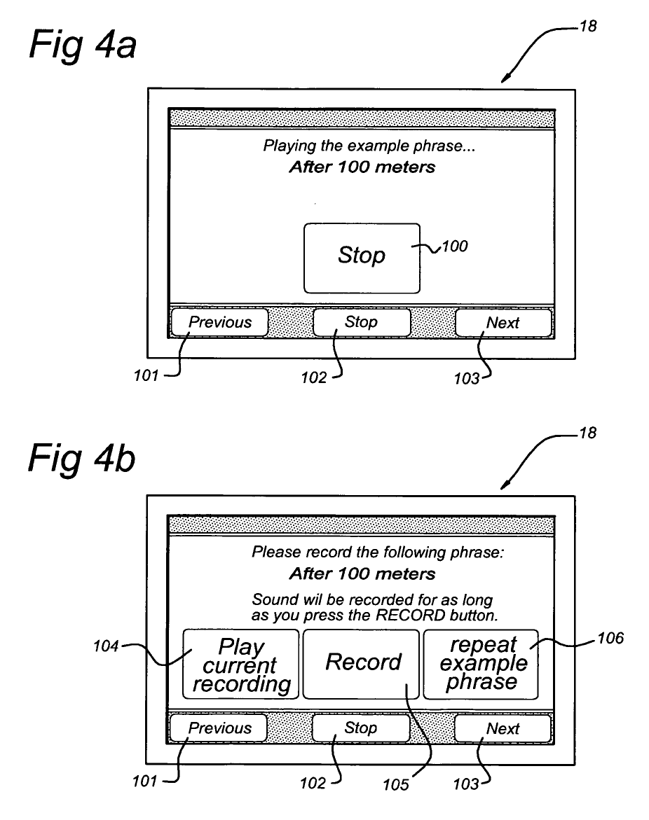

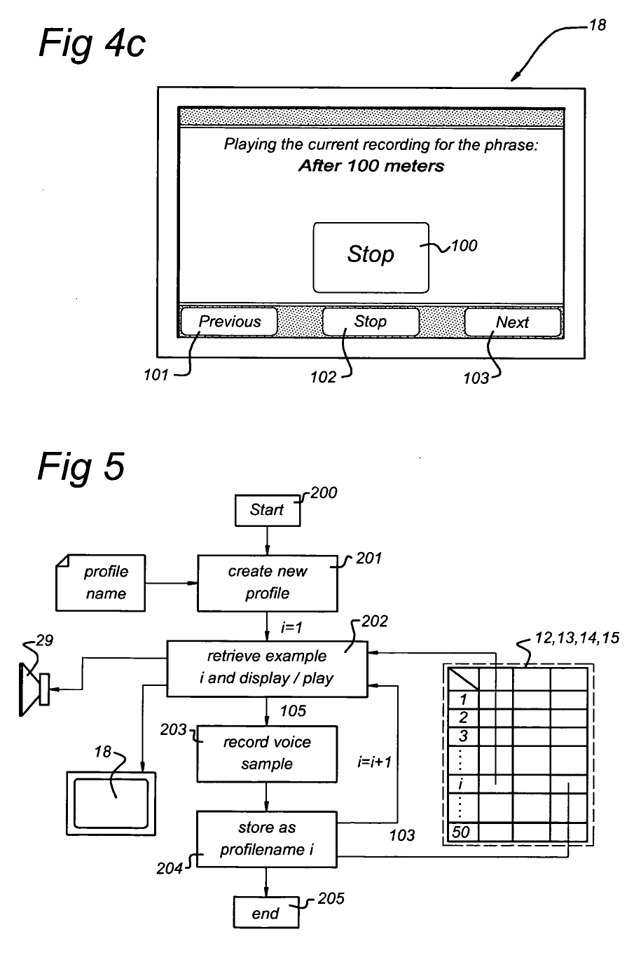

After this, the navigation device 10 takes the user through a sequence of screens that tell the user what to do and/or say. An example of the voice sample is shown on the display 18 and/or is played through the speaker 29. In case the navigation device 10 both displays the voice sample and plays the voice sample through the speaker, the navigation device 10 may show a screen as depicted in FIG. 4a.

When button 100 is pressed, the navigation device 10 stops playing the example of the voice sample through speaker 29.

During the interactive process to record a new set of voice samples the user is given the opportunity to record a new set of voice samples. During this interactive process the user is given the option to go back to a previous voice sample by pressing the previous button 101. In case there is no previous voice sample (in case it is the first voice sample) the previous button 101 may be dimmed.

Further, the user is given the option to skip the recording of a voice sample and proceed with the recording of the next voice sample by pressing the next button 103. In case there is no next voice sample (in case it is the last voice sample) the next button 101 may be dimmed.

The user may also stop the interactive process by pressing the stop button 102. Pressing the stop button 102 may cause the navigation device 10 to display a verify query: “do you wish to stop recording your own voice?” including a yes and no button.

After a predetermined time, or in case the voice sample is played through the speaker 29, after the speaking is finished, the navigation device 10 may show a screen as schematically depicted in FIG. 4b.

When the user presses the record button 105 the navigation device 10 starts recording the sound as registered by the microphone 24, by storing the electrical sound signal as outputted by the microphone 24 in memory devices 12, 13, 14, 15. The navigation device 10 may record the sound as registered by the microphone 24 for as long as the record button 105 is pressed.

According to an embodiment, the navigation device 10 may first process the electrical sound signal as received from the microphone 24 before storing the electrical sound signal in memory devices 12, 13, 14, 15. The processing of the electrical sound signal may for instance comprise filtering, transferring from analogue to digital or vice versa, a noise reduction filter, a low-pass filter, a high frequency boost filter etc.

After a new voice sample is recorded and stored in memory devices 12, 13, 14, 15, the user may want to hear the recorded voice sample. This may be done by pressing button 104: play current recording. When the user presses button 104, the navigation device 10 retrieves the recorded voice sample from memory devices 12, 13, 14, 15 and plays it over the speaker 29. During this the navigation device 10 may display a screen according to FIG. 4c. In case no recording has been stored yet, button 104 may be dimmed.

Finally, the navigation device 10 may provide the user with the option to listen to the example phrase again by pressing button 106.

FIG. 5 schematically depicts a flow diagram of the actions as may be performed by the navigation device 10 when the interactive process of recording a new set of voice samples is being executed. These actions may be performed by the processor unit 11 of the navigation device 10. The memory devices 12, 13, 14, 15 may comprise program instructions that make the navigation device 10 perform the interactive process of recording a new set of voice samples or the actions of the flow diagram depicted in FIG. 5.

After the user has indicated that he/she wants to record a new set of voice samples, the interactive process is started (start action 200). The navigation device 10 may show the introduction message as described above.

In action 201 a new profile is created and stored in memory devices 12, 13, 14, 15. In FIG. 5, the different columns of the table represent different profiles. The profile is given a profile name (e.g. newprofile) which may be determined as described above.

In a next action 202, an example voice sample i is retrieved from the memory device 12, 13, 14, 15 and displayed using display 18 and/or played using speaker 29. The value of i may be set to 1 in action 201. The example voice sample may be any voice sample that is already stored in the memory devices 12, 13, 14, 15 labelled with the appropriate number i.

In a further action 203, when button 105 is pressed (record) a new voice sample is recorded using microphone 24. In action 204, the recorded voice sample is stored in the memory devices 12, 13, 14, 15 and labelled as newprofile.i. After this, for instance when button 103 (next) is pressed, actions 202, 203, 204 are repeated with i=i+1.

When during the execution of the flow diagram as depicted in FIG. 5, button 101 (previous) is pressed, i is lowered (i=i−1) and the navigation device 10 may proceed with action 202.

When during the execution of the flow diagram as depicted in FIG. 5, button 102 (stop) is pressed the navigation device 10 stops with the execution and may proceed with action 205 (end).

When during the execution of the flow diagram as depicted in FIG. 5, button 103 (next) is pressed, i is raised (i=i+1) and the navigation device 10 proceeds with action 202.

When during the execution of the flow diagram as depicted in FIG. 5, button 104 is pressed (play current recording), the navigation device 10 retrieves newprofile.i from the memory devices 12, 13, 14, 15 (if available) and plays newprofile.i using speaker 29. After this, the navigation device 10 may proceed with action 203.

When during the execution of the flow diagram as depicted in FIG. 5, button 106 is pressed (repeat example phrase), the navigation device 10 jumps back to action 202 (i=i) and retrieves an appropriate example voice sample stored in the memory devices 12, 13, 14, 15 labelled with the appropriate number i and plays this voice sample using speaker 29. After this, the navigation device may proceed with action 203.

When i has reached a predetermined maximum value, for instance 50, the interactive process is stopped (action 205: end). Also, when button 102 (stop) is pressed, the interactive process is stopped (action 205: end).

It will be understood that the flow diagram as depicted in FIG. 5 is only an example, and that many variations may be conceived.

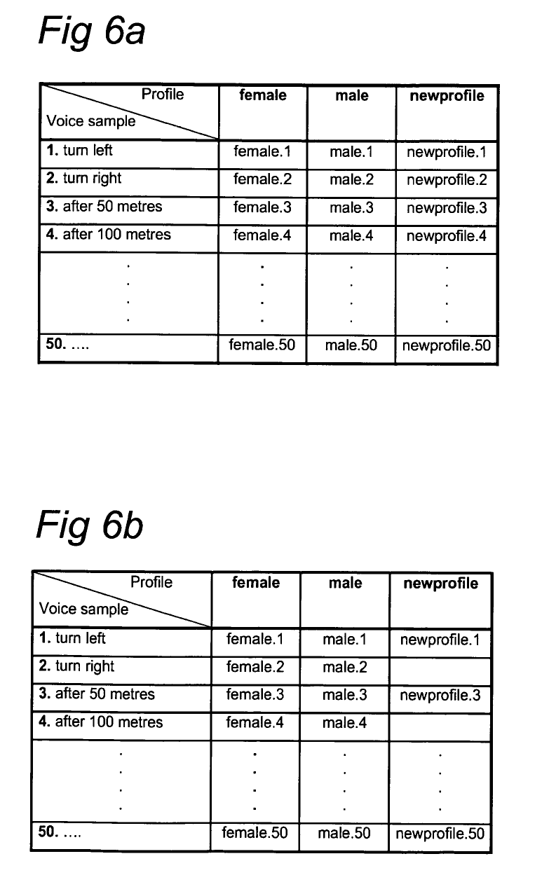

The interactive process results in a new profile (e.g. newprofile) stored in memory devices 12, 13, 14, 15, now comprising one additional profile. Where, according to the example shown in FIG. 3, the memory devices 12, 13, 14, 15 comprise two profiles (female and male), the memory devices 12, 13, 14, 15 now comprise three profiles: female, male and newprofile. Each voice sample of newprofile is given a unique identification code. This is depicted in FIG. 6a.

When the user uses the navigation device 10 to navigate, he/she may select newprofile. This causes the navigation device 10 to use the voice samples stored in this profile to provide navigation instructions using voice guidance to guide the user.

So, instead of playing male.4 and male.1, as in the example above, the navigation device 10 plays newprofile.4 and newprofile.1.

However, based on the above, it will be understood that not all voice samples of newprofile are necessarily recorded when action 205 is reached. During the interactive process of recording new voice samples, the user may have skipped one or more recordings by pressing button 103 (next) or by pressing button 102 (stop). In such a case, the newprofile may comprise empty voice samples, as schematically depicted in FIG. 6b, in which newprofile.2 and newprofile.4 are not recorded.

When the user uses the navigation device 10 to navigate and has selected newprofile, the navigation device 10 can't play some navigation instructions.

For instance, according to the example shown in FIG. 6b, the navigation device 10 is capable of playing “after 50 metres, turn left” (newprofile.3 and newprofile.1), but can't play “after 50 metres, turn right” or “after 100 metres, turn right”, as this requires voice samples of newprofile that aren't stored in the memory devices 12, 13, 14, 15, i.e. are not available in the selected profile.

In that case, the navigation device 10 may be arranged to retrieve a voice sample having the same number assigned to of a different profile. For instance, when the navigation instruction: “after 50 metres, turn right” is to be played, the navigation device 10 checks if newprofile.3 and newprofile.2 are available. Since newprofile.2 is not available, the navigation device 10 retrieves a voice sample of the same number of a different profile, for instance male.2. As a result, the navigation instruction “after 50 metres, turn right” can now be played by playing newprofile.3 and male.2.

According to an embodiment, the navigation device 10 may be arranged to retrieve all voice samples of a sequence of voice samples from a different profile, when at least one of the voice samples of the sequence of voice samples is not available in the selected profile. So, according to the example above, instead of playing newprofile.3 and male.2, the navigation device 10 plays male.3 and male.2 over speaker 29. This may prevent a user to be confronted with navigation instructions spoken by two different voices.

In order to perform the above, the navigation device 10 may store and generate profiles in a hierarchical order. The navigation device 10 may give a user the possibility to derive profiles one from another. When using text-to-speech, it's preferable to derive profiles one from each other with a same or similar language or actor (male or female) identification.

If a voice sample is not available in a first selected profile, the navigation device 10 may be arranged to look up the voice sample in a second, parent profile. If the voice sample is not available in the second, parent profile, the navigation device 10 may be arranged to look up the voice samples in a third profile, being a parent profile of the second profile, etc. The sound sample search operation stops when it reaches a profile that is highest in the hierarchy, i.e. a profile from which the whole profile tree was derived. It may be a default profile, pre-installed on the navigation device 10. Because some intermediate or even default profile could be deleted by user in the process of using the navigation device 10, the sound sample search operation should skip those missing profiles or treat them as not having any sound samples while doing backward search.

In case the voice sample still can not be found even after applying the backward sound sample search procedure like described above, the navigation device 10 may be arranged to look up the voice sample in an existing default profile, for instance a default profile for a selected language of operation for the navigation device 10.

In case the voice sample can still not be found, the navigation device 10 may be arranged to look up the voice sample in an existing default or user profile, that matches with the current profile according to criteria like the ‘same language but different actor (male voice instead of female voice, etc.)’, ‘the same language group’, etc. In this case a switch from one profile derivation tree to another is possible in a sound sample search procedure. In case of such switch, the search procedure can recursively apply steps described above.

In should be understood for person skilled in art that the sound sample search steps described above could be applied in different order or non-recursively or skipped depending from physical limitations of navigation device and to provide better user experience.

Default profiles and/or default languages are pre-installed on the navigation device 10 and their internal content may be unchangeable for a user. A user may only delete some of the default profiles to free space on the navigation device 10 memory devices 12, 13, 14, 15 for storing for instance media for new maps or update a default profile to a newer version that may be distributed by the manufacturer of device, for example. Current profiles and current languages may be changed.

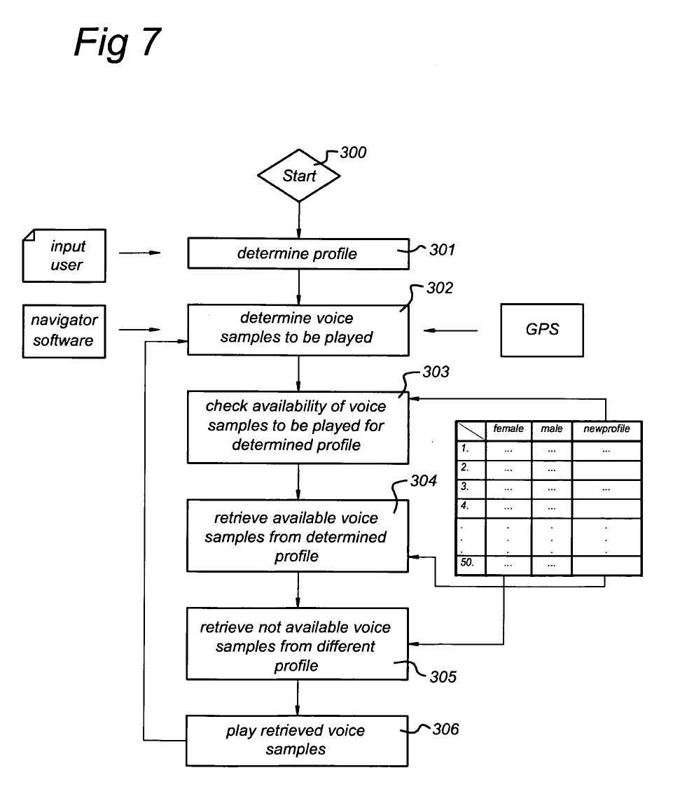

This is further depicted by the flow diagram of FIG. 7. After a first start action 300, the navigation device 10 determines the profile that is to be used. This may be done by providing the user with the option to choose from all available profiles. The input from the user may be done using input devices, such as keyboard 16, mouse 17, or display 10 being a touch screen. The user may select newprofile.

Once the profile has been determined, the navigation device 10 proceeds with action 302, in which the navigation device determines which voice samples are to be played. This is done based on navigation instructions for instance generated by the navigation software, as described above. Deciding when to play which voice samples may be done using input from positioning device 23, such as a GPS.

In a next action 303, the navigation device 10 checks whether the voice samples to be played are available in the selected profile, according to this example, newprofile. Once this is done, in action 304, the navigation device 10 retrieves the available voice samples from the determined profile (newprofile) from the memory devices 12, 13, 14, 15. If needed, the navigation device 10 may retrieve the voice samples that are not available in the selected profile (newprofile) from another profile, for instance ‘female’.

Finally, the navigation device 10 plays the retrieved voice samples in action 306. After this, the navigation device returns to action 302 to await further input from the navigation software to play further navigation instructions.

According to a further embodiment, instead of retrieving voice samples from another profile when not available in a selected profile, the navigation device 10 may also be arranged to complete an incomplete profile taking voice samples from another complete profile.

The different profile may be a profile, of which all voice samples are available. The different profile may be a predetermined profile, or a profile selected by a user.

Voice samples may be stored in any suitable data format, for instance as MP3 files or WAV files.

In the above, where the term ‘voice samples’ is used, it will be understood that in principle any sound sample may be used. Sound samples may for instance be sound samples of distinctive sounds, songs, tunes etc. for different navigation instructions.

Based on the above, a user may also record a sound, such as a song or tune, for just one navigation instruction. For instance, the navigation instruction: destination reached, may be replaced by a tune, while all other navigation instructions are taken from an already generated profile.

According to a further embodiment, the navigation device 10 may be provided with text-to-speech techniques, as described above. According to this embodiment, the interactive process may be used to record a new set of phonetic data, such as short sound samples (voice fragments, sounds, etc).

According to such an embodiment, the interactive process may take longer and the user may be ask to record not only whole phrases, but sounds, like for instance pronouncing certain phrases, sounds or characters (a, e, ou).

Depending on the language, which may be inputted (upon request) by a user, or may be read from the settings of the navigation device 10 (current selected language), the navigation device 10 may be arranged to ask the user to record different phrases, sounds or characters.

According to a further embodiment, the navigation device 10 may be provided with possibility to exchange user profiles and/or sound samples with other devices, such as other navigation device 10 of the same kind, or other devices that substantially support the same functionality by copying one or more profiles, for instance via physical storage media, transmitting one or more profiles via network 27 using input-output device 25 described above. The input-output device 25 may be used to set up a one or two communication link with such an other device. The communication link and network 27 may be any type, such as Bluetooth, RF-network. The communication link may be wired or wireless.

According to a further embodiment the navigation device 10 may be arranged to delete or remove profiles from memory device 12, 13, 14, 15. This may be done upon request of a user. The navigation device 10 may also be arranged to delete or remove all incomplete profiles from memory device 12, 13, 14, 15. This provides the user with an easy option to limit or reduce the amount of data stored in the memory device 12, 13, 14, 15. The navigation device 10 may be arranged to delete default profiles as described above. The navigation device 10 may also be arranged to update default or user profiles to a newer version or put a deleted default profile back assuming its data are provided from an external source.

According to a further embodiment, the navigation device 10 is arranged to stop the interactive process in the middle (e.g. by pressing button 102 (stop)) and store in the memory device 12, 13, 14, 15 the current status of the interactive process (e.g. storing the value of I when the interactive process was aborted). This provides the possibility to resume the interactive process at a later moment in time from that saved point. Using this in combination with the option of exchanging profiles between devices 10 allows the user to record part of a profile on a first device, transmit it to a second device and finish or continue the recording on the second device.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. It will be understood by a skilled person that all software components may also be formed as hardware components.

The descriptions above are intended to be illustrative, not limiting. Thus, it will be apparent to one skilled in the art that modifications may be made to the invention as described without departing from the scope of the claims set out below.

1. Navigation device comprising:
a processor unit,
memory device,
a speaker, the memory device comprising a plurality of sound samples, the navigation device being arranged to play a selection of the sound samples over the speaker to provide navigation instructions, and
an input device for receiving sound samples, the input device being arranged for storing the received sound samples in memory device for subsequent playback over speaker for providing navigation instructions.

2. Navigation device according to claim 1, where the input device comprises a microphone.

3. Navigation device according to claim 1, wherein at least part of the sound samples are voice samples.

4. Navigation device according claim 1, wherein the selection of sound samples is played over speaker using text-to-speech voice generation.

5. Navigation device according to claim 4, wherein the navigation instructions are generated from the received sound samples using text-to-speech voice generation.

6. Navigation device according to claim 1, wherein the input device comprises an input/output device, arranged to exchange sound samples with other devices.

7. Navigation device according to claim 1, wherein the memory device is arranged to store instructions and data to allow the processor unit to run a program to calculate navigation instructions.

8. Navigation device according to claim 1, wherein the plurality of sound samples are organized in two or more profiles, wherein each profile comprises a number of sound samples, and each sound sample has a sample identification assigned to it, and wherein each sample identification represents a navigation instruction or part of a navigation instruction.

9. Navigation device according to claim 8, wherein the navigation device is arranged to store a sound sample received from the input device in a profile in the memory device and assign a sample identification to the sound sample.

10. Navigation device according to claim 8, wherein the navigation device is arranged to create a new profile and store a sound sample received from the input device in the new profile in the memory device and assign a sample identification to the sound sample.

11. Navigation device according to claim 8, the navigation device being arranged to play a selection of the sound samples over speaker to provide navigation instructions from a first profile, and when a sound sample of the selection having a sample identification is not available in a first profile, the navigation device being arranged to play a similar sound sample from a second profile.

12. Navigation device according to claim 8, the navigation device being arranged to play a selection of the sound samples over speaker to provide navigation instructions from a first profile, and when at least one sound sample of the selection having sample identifications is not available in a first profile, the navigation device being arranged to play all sound sample of the selection from a second profile.

13. Navigation device according to claim 11, wherein the first and second profile are in an hierarchical order with respect to each other.

14. Vehicle, comprising a navigation device according to claim 1.

15. Method for recording a set of sound samples, the method comprising:
recording a sound sample using an input device for receiving sound samples, and
storing the recorded sound sample in memory device for subsequent playback for providing navigation instructions.

16. Method according to claim 15, wherein sample identifications are assigned to sound samples, the sample identifications representing navigation instructions or part of navigation instructions, the method further comprising before recording the sound sample using an input device for receiving sound samples:
providing an example for a sound sample having a sample identification to a user, and, when storing the recorded sound sample, and
assigning a unique identification code to it, at least comprising the sample identification.

17. Method according to claim 15, wherein the example is provided via at least one of: display, a speaker.

18. Method for providing navigation instructions by playing a selection of sound samples from a first profile over a speaker, the method further comprising:
retrieving sound samples from memory device according to the selection of sound samples, and, if one or more of the selection of sound samples is not available in the first profile, and
retrieving the one or more sound samples not available in the first profile from a second profile stored in memory device.

19. Method according to claim 18, wherein if at least one the selection of sound samples is not available in the first profile, the method further comprises:
retrieving all sound samples of the selection from the second profile stored in memory device.

20. Computer program, when loaded on a computer arrangement, arranged to perform the method according to claim 15.

21. Data carrier, comprising a computer program according to claim 20.

22. Computer program, when loaded on a computer arrangement, arranged to perform the method according to claim 18.

23. Data carrier, comprising a computer program according to claim 22.

24. A computer readable medium including program segments for, when executed on a computer device, causing the computer device to implement the method of claim 15.

25. A computer readable medium including program segments for, when executed on a computer device, causing the computer device to implement the method of claim 18.
